(19) United States
(12) Patent Application Publication
(10) Pub. No.: US 2002/0169997 A1
(43) Pub. Date: Nov. 14, 2002

(54) BIOS debug method

(76) Inventor: Song-Bor Chen, Taipei (TW)

Correspondence Address: BIRCH, STEWART, KOLASCH & BIRCH, LLP, P.O. BOX 747, Falls Church, VA, 22040-0747, US

(21) Appl. No.: 09/774,721

(22) Filed: Feb. 1, 2001

(51) Int. Cl. G06F 9/44; H04L 1/22

(52) U.S. Cl. 714/25

(57) ABSTRACT

The present invention pertains to a BIOS debug method, which adds an error output command (a command that outputs a particular to a debug port) at a proper position in each sub-routine of a power on self test (POST) and inserts a condition before the error output command so that only when the condition holds will the error output command be compiled and executed. The place to put in the error output command can be when there is more than one setting or initialization hardware devices or a test step is too tedious. Through the condition, the enable state of the error output command can be controlled to be enable or disable, whereby the BIOS is determined to be a test version or a final version. The invention thus provides a test operation in manufacturing that can correctly find out the hardware or cause that results in test errors without affecting the BIOS execution efficiency under normal uses.

### BACKGROUND OF THE INVENTION

1. Field of Invention

The present invention relates to a BIOS debug method that is particularly designed for the power on self test period to find out the hardware or cause resulting in test errors. That is, the invention is a debug method designed for test operations in BIOS manufacturing.

2. Related Art

The power on self test (POST) is a part of the basic input output system (BIOS). When the power of a computer is turned on, the POST will be first executed to test or initialize hardware devices. Only when all the hardware devices are confirmed to be working in normal conditions will the operating system be loaded in. The POST program is composed of a series of sub-routines. Each sub-routine may contain several hardware test or initialization actions. At the same time the POST runs each sub-routine in order, the code of the sub-routine will be output to a debug port with a particular I/O address. When the POST ceases due to an error occurring some action, the debug port will be accessed to indicate which sub-routine encounters the error.

Even if a technician knows in the POST which sub-routine has an error, he is still not able to correctly determine which hardware device is out of order because each sub-routine may test and initialize several hardware devices according to some classification or design. Therefore, even if one knows that the error occurs in a sub-routine, he would not be able to know for sure which hardware device causes this error.

For example, in current technologies, the sub-routine of POST 01 in a computer system needs to run the following four steps:

1. Out debug port with POST function number=01 h

2. call POST_{—}01h sub-routine

Setup HDD controller

Reset HD drivers

Update CPU micro-code

Config and enable L2 cache

### POST Code 1

However, before the sub-routine of the POST program is executed, an o1 h value will be output. If the system is currently in this sub-routine, there is no way to determine whether the HD controller is out of order or something goes wrong when enabling cache.

Therefore, technicians have to spend a lot of time to perform detailed tests on each hardware device called by the sub-routine. This indeed wastes time and human resources.

### SUMMARY OF THE INVENTION

It is an object of the invention to provide a debug method that can correctly find out the hardware or cause resulting in test errors in the BIOS power on self test (POST) period.

It is another object of the invention to provide a debug method that can correctly find out error causes without affecting the execution efficiency of the BIOS in uses.

The disclosed method inserts an error output command when there are more than one test or initialization hardware devices or at a proper position in a sub-routine that has tedious test steps. The inserted error output command outputs a particular value to a debug port after any hardware device test or initialization. The disclosed method also inserts a condition before the error output command so as to determine whether the error output command should be compiled together with the sub-routine. Therefore, through the control of the condition, technicians can decide if the BIOS is a test version for debugging or a final version ready for shipping.

Other features and advantages of the present invention will be apparent from the following detailed description, which proceeds with reference to the accompanying drawing.

### BRIEF DESCRIPTION OF THE DRAWINGS

FIG. 1 is a complete test flowchart of the invention.

### DETAILED DESCRIPTION OF THE INVENTION

The method disclosed herein can help technicians correctly find out the hardware or cause that results in BIOS test or initialization errors during the power on self test (POST) period. The method can be achieved through the steps of:

inserting an error output command; and

enabling the error output command.

The step of inserting an error output command puts in an error output command after any hardware test or initialization step for those sub-routines testing or initializing more than one hardware devices or having tediously long test steps. The function of the error output command is to output a particular value to a debug port after each hardware device test or initialization. Once some hardware device causes an error or failure, technicians can correctly identify which hardware device by reading in the value of the debug port, thus solving the problem.

After inserting the error output command, the POST program must occupy a larger space in BIOS than before. Such a BIOS debug function may be unnecessary for consumers and a bigger POST program will affect the BIOS execution efficiency.

Therefore, the step of enabling the error output command serves to determine the BIOS version. Through the insertion of this step, one can determine whether the BIOS with the POST program is a test version BIOS for technicians to debug or a final version BIOS for consumers to use. To implement the function, a condition is inserted before each error output command. Only when the condition holds will the error output command be compiled and executed in the POST operation to output a particular value to the debug port after any hardware device test or initialization by the sub-routine.

Taking the previously mentioned POST code 1 as an example, the sub-routine POST01 is written according to the present invention as follows:

| 1. Out debug port with POST function number =0lh | |
|---|---|
| 2. call POST_01h sub-routine: | |
| Setup HDD controller | |
| if # debug enable | ←inserted condition |
| out debug port with E1h | ←inserted error output command |
| Reset HD drivers | |
| if # debug enable | ←inserted condition |
| out debug port with E2h | ←inserted error output command |
| Update CPU micro-code | |
| if # debug enable | ←inserted condition |
| out debug port with E3h | ←inserted error output command |
| Config and enable L2 cache | |
| if # debug enable | ←inserted condition |
| out debug port with E4h | ←inserted error output command |
| | [POST code 2] |

“E1h”, “E2h”, “E3h”, and “E4h” in POST code 2 are the particular values output from each of the error output commands to the debug port. Of course, the value is not limited to the ones mentioned in the example.

According to the technical means disclosed herein, whether the condition before the error output command holds can be determined by reading in a particular variable assigned by a programmer. Alternatively, if can be a condition that does not hold except for a particular value. In the POST code 2, “debug” is a variable whose data format can be defined to be a logic value (false or true). Therefore, the technician can make the condition hold by sending a command (e.g., debug=true or debug=false) or changing the logic value. Therefore, he is able to determine whether the error output command after the condition should be inserted into the POST program before the BIOS perform the POST operations.

Once the condition holds, the inserted error output command will be compiled and added into the POST program. That is, the error output command is enabled to output a particular value to the debug port after any hardware device test or initialization in the sub-routine. Of course, to increase the BIOS debug test efficiency, the technician can first perform POST in a usual way with error output commands disabled. If he finds that a BIOS is out of order or produces errors, he can send a command to enable the error output command (the BIOS is then the test version BIOS) so as to trace the hardware device or cause that results in BIOS errors. Once the BIOS passes POST, the technician can disable the error output command for the consumers (this is the final version BIOS). Therefore, when the consumer is using the BIOS, the inserted error output command will not be compiled and the execution efficiency of the BIOS will not be affected.

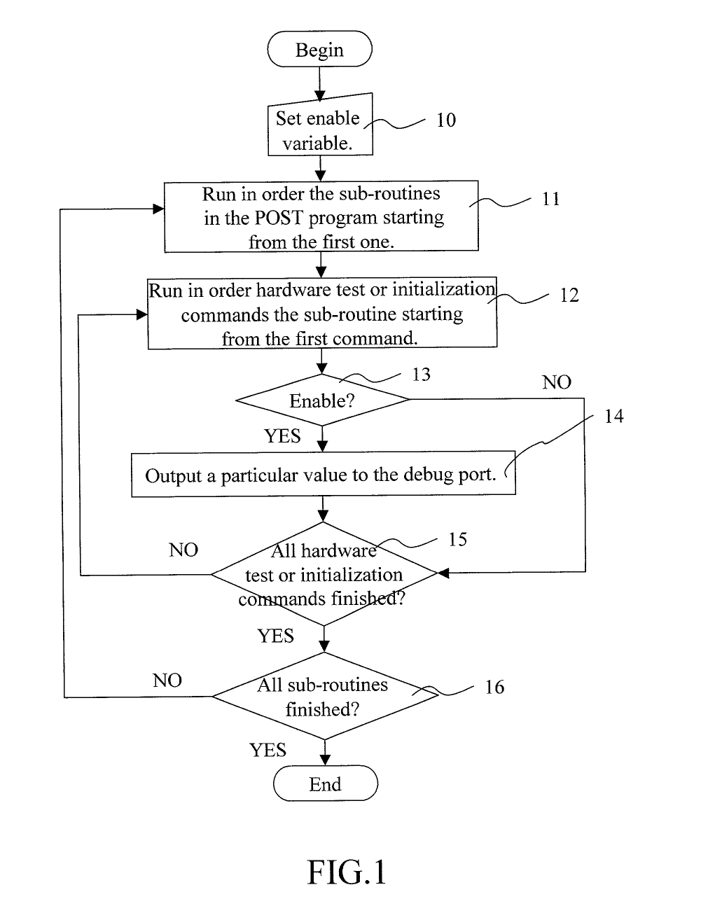

Finally, with reference to FIG. 1, a technician first set the value of an enable variable (step 10) to determine whether some particular value needs to be output to a debug port after any hardware test or initialization during the POST. A first sub-routine in the POST program is executed (step 1) and the whole POST ends until all sub-routines are finished (step 16). In each sub-routine, each hardware device test or initialization is executed in order (step 12). When the enable variable is set to “enable” (step 13), a particular value is output to the debug port (step 14). On the contrary, if the enable variable is set to “disable” (step 13), the loop is continued until all hardware device tests or initialization steps in the current sub-routine are finished (step 15). Afterwards, the procedure goes into the loop between step 11 and step 16 until all sub-routines are executed.

Effects of the Invention

1. The present invention can correctly find out the hardware device or cause of a test error.

2. The present invention can save time and human resources. If one can save 30 minutes on the average for a BIOS test using the disclosed method, then a considerable amount of work time will be saved for every thousand pieces.

3. The present invention does not affect the execution efficiency of the final version BIOS. When compiling the POST program code in the BIOS, a proper command can be given to set the BIOS as a test version BIOS for debugging or a final version BIOS for consumers. Therefore, these two versions do not interfere with each other and the execution efficiency of the final version will not be affected.

Certain variations would be apparent to those skilled in the art, which variations are considered within the spirit and scope of the claimed invention.

What is claimed is:

1. A BIOS debug method to correctly find out the hardware device or cause that results in a test error during the power on self test (POST) period of the BIOS, the method comprising:
the step of inserting an error output command, which inserts an error output command after any hardware device test or initialization step in the sub-routine of the POST program so as to output a particular value to a debug port after the hardware device test or initialization step; and
the step of enabling the error output command, which inserts a condition before the error output command so that the error output command is enabled to output the particular to the debug port when the condition holds.

2. The method of claim 1, wherein the validity of the condition is determined by setting a particular variable and detecting the value of the particular variable.

3. The method of claim 2 further comprising the step of setting the particular variable.

4. The method of claim 1, wherein the error output command is compiled and added into the POST program only when the condition holds.
